(19) United States
(12) Patent Application Publication
(10) Pub. No.: US 2025/0280145 A1
(43) Pub. Date: Sep. 4, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Zhipin DENG, Beijing (CN); Li ZHANG, Los Angeles, CA (US)

(21) Appl. No.: 19/210,882

(22) Filed: May 16, 2025

Related U.S. Application Data
(63) Continuation of application No. PCT/CN2023/132469, filed on Nov. 17, 2023.

(30) Foreign Application Priority Data
Nov. 18, 2022 (WO) PCT/CN2022/133020

(51) Int. Cl. H04N 19/52; H04N 19/139; H04N 19/176; H04N 19/186

(52) U.S. Cl. CPC H04N 19/52; H04N 19/139; H04N 19/176; H04N 19/186

(57) ABSTRACT

Embodiments of the present disclosure provide a solution for video processing. A method for video processing is proposed. The method comprises: determining, for a conversion between a current video block of a video and a bitstream of the video, affine motion compensation information of the current video block; preforming a refinement process on the affine motion compensation information based on at least one sample previously coded to obtain refined affine motion compensation information; and performing the conversion based on the refined affine motion compensation information.

### CROSS REFERENCE TO RELATED APPLICATION

This application is a continuation of International Application No. PCT/CN2023/132469, filed on Nov. 17, 2023, which claims the benefit of International Application No. PCT/CN2022/133020 filed on Nov. 18, 2022. The entire contents of these applications are hereby incorporated by reference in their entireties.

### FIELDS

Embodiments of the present disclosure relates generally to video processing techniques, and more particularly, to affine motion compensation refinement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, affine motion compensation information of the current video block; preforming a refinement process on the affine motion compensation information based on at least one sample previously coded to obtain refined affine motion compensation information; and performing the conversion based on the refined affine motion compensation information. The method in accordance with the first aspect of the present disclosure refines the affine motion compensation information. For example, control point motion vector (CPMV) used in the affine motion compensation can be refined. In this way, the coding efficiency and coding effectiveness can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining affine motion compensation information of a current video block of the video; preforming a refinement process on the affine motion compensation information based on at least one sample previously coded to obtain refined affine motion compensation information; and generating the bitstream based on the refined affine motion compensation information.

In a fifth aspect, a method for storing a bitstream of a video is proposed. The method comprises: determining affine motion compensation information of a current video block of the video; preforming a refinement process on the affine motion compensation information based on at least one sample previously coded to obtain refined affine motion compensation information; generating the bitstream based on the refined affine motion compensation information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6A illustrates a 4-parameter control point based affine motion model;

FIG. 6B illustrates a 6-parameter control point based affine motion model;

FIG. 7 illustrates an affine MVF per subblock;

FIG. 8 illustrates locations of inherited affine motion predictors;

FIG. 9 illustrates control point motion vector inheritance;

FIG. 10 illustrates locations of candidates position for constructed affine merge mode;

FIG. 11 illustrates spatial neighbors for deriving affine merge candidates, where (a) in FIG. 11 is for deriving inherited affine merge candidates, and (B) in FIG. 11 is for deriving constructed affine merge candidates;

FIG. 12 illustrates a diagram from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performing on a search area around initial MV;

FIG. 16 illustrates a template and the corresponding reference template;

FIG. 17 illustrates a template and reference template for block with subblock motion using the motion information of the subblocks of current block;

FIG. 18 illustrates a diagram showing deriving sub-CU motion field obtained by applying a motion shift based on the neighboring motion information;

FIG. 19 illustrates a flowchart of a method for video processing in accordance with embodiments of the present disclosure;

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

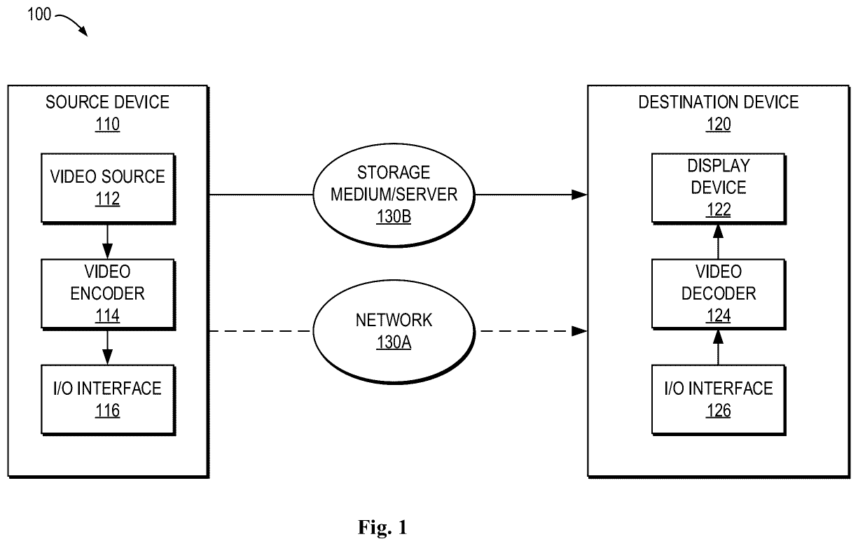

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

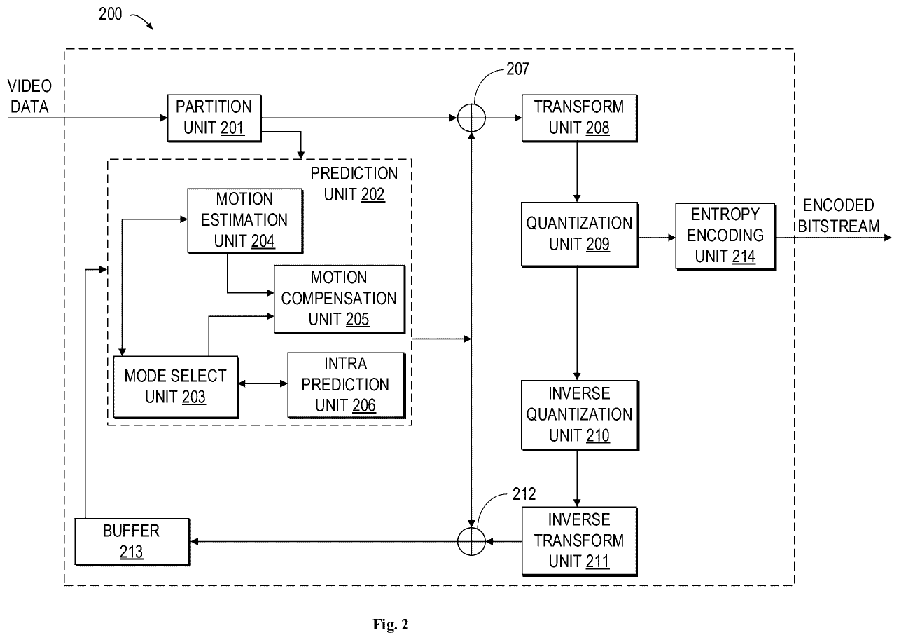

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

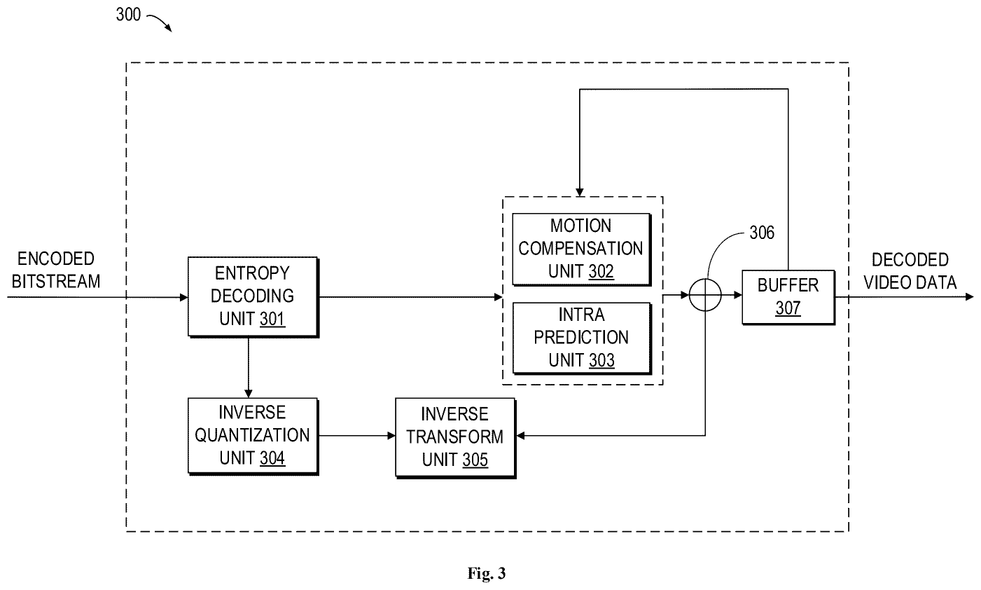

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about Affine motion prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

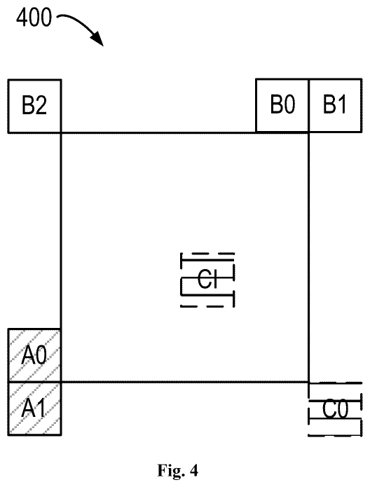

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates a diagram 400 of positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

Merge mode: Similar to AMVP mode, MVP candidate list for merge mode comprises of spatial and temporal candidates as well. For spatial motion vector candidate derivation, at most four candidates are selected with order A1, B1, B0, AO and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

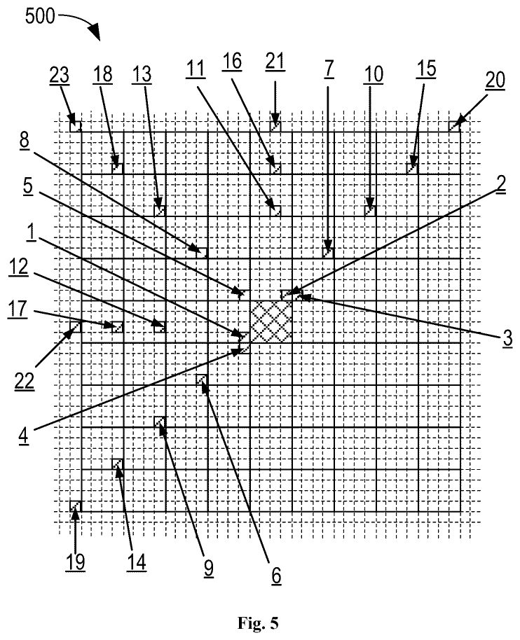

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5, which illustrates a diagram 500 of positions of non-adjacent candidate in ECM.

### 2.2. Affine Motion Compensated Prediction

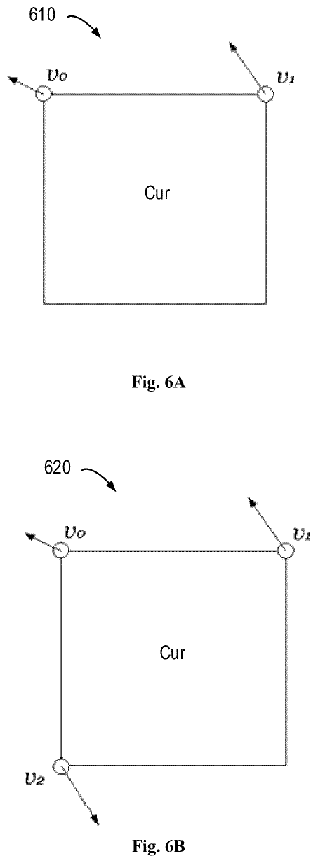

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 6A illustrates a diagram 610 of a 4-parameter control point based affine motion model. FIG. 6B illustrates a diagram 620 of a 6-parameter control point based affine motion model. As shown in FIG. 6A and FIG. 6B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 y}}{W} y + {mv}_{0 y}\end{matrix} . \qquad ( 1 )$$

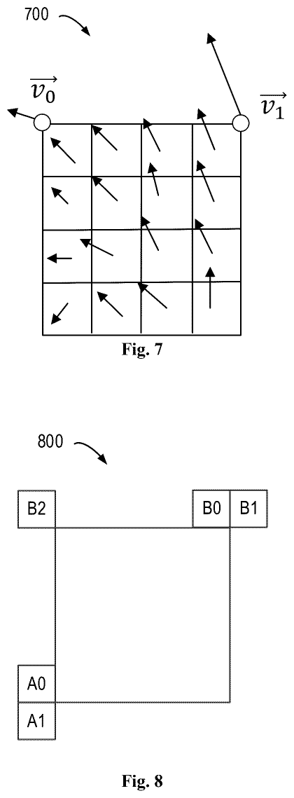

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point. FIG. 7 illustrates an example diagram 700 of affine MVF per subblock. In order to simplify the motion compensation prediction, block based affine transform prediction is applied. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region. As done for translational motion inter prediction, there are also two affine motion inter prediction modes: affine merge mode and affine AMVP mode.

### 2.2.1. Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signaled to indicate the one to be used for the current CU. In VVC, the following three types of CPVM candidate are used to form the affine merge candidate list:
Inherited affine merge candidates that extrapolated from the CPMVs of the neighbour CUs,
Constructed affine merge candidates CPMVPs that are derived using the translational MVs of the neighbour CUs,
Zero MVs.

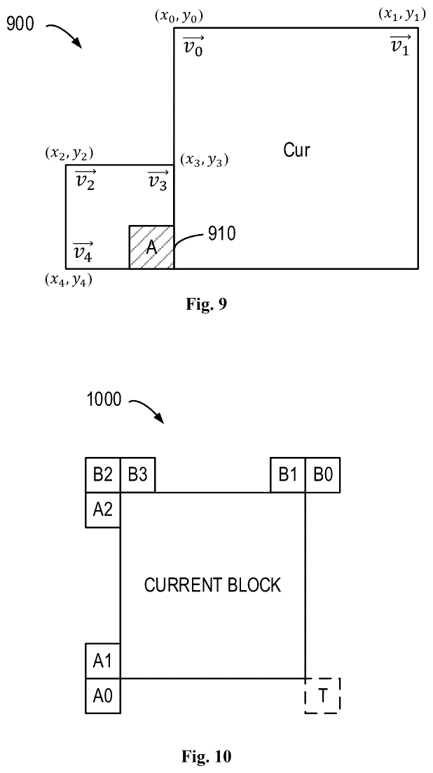

In VVC, there are maximum two inherited affine candidates, which are derived from affine motion model of the neighboring blocks, one from left neighboring CUs and one from above neighboring CUs. FIG. 8 illustrates an example 800 of locations of inherited affine motion predictors. The candidate blocks are shown in FIG. 8. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 9 illustrates an example diagram 900 of control point motion vector inheritance. As shown in FIG. 9, if the neighbour left bottom block A 910 is coded in affine mode, the motion vectors v₂, V₃ and V₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbor translational motion information of each control point. FIG. 10 illustrates a diagram 1000 of locations of Candidates position for constructed affine merge mode. The motion information for the control points is derived from the specified spatial neighbors and temporal neighbor shown in FIG. 10. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs,
Constructed affine AMVP candidates CPMVPs that are derived using the translational MVs of the neighbour CUs,
Translational MVs from neighboring CUs,
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable. If affine AMVP list candidates is still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods in ECM-6.0

In ECM-6.0, 3 additional Affine merge and AMVP candidate derivation methods are integrated, which are Non-adjacent spatial candidates, History-parameter-based candidates and Regression based affine candidates.

### 2.2.3.1. Non-Adjacent Spatial Candidates

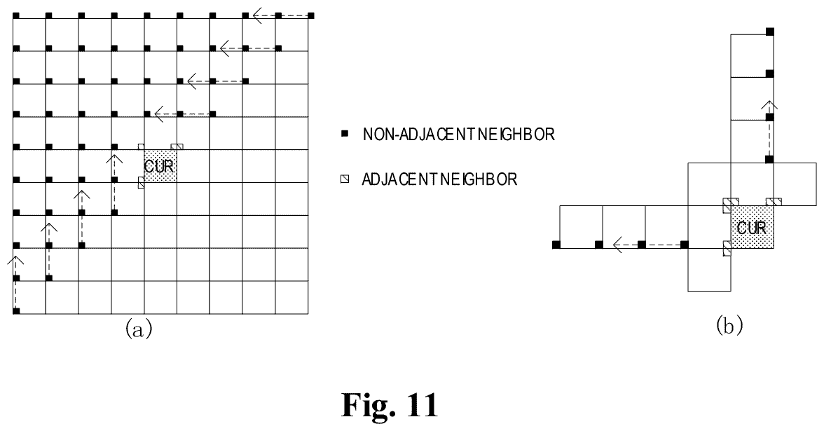

In ECM-6.0, non-adjacent spatial neighbors are investigated to provided candidates for both Affine merge and Affine AMVP. FIG. 11 illustrates of spatial neighbors for deriving affine merge candidates. The pattern of obtaining non-adjacent spatial candidates is shown in FIG. 11. Same as the non-adjacent regular merge candidates, the distances between non-adjacent spatial candidates and current coding block are also defined based on the width and height of current CU.

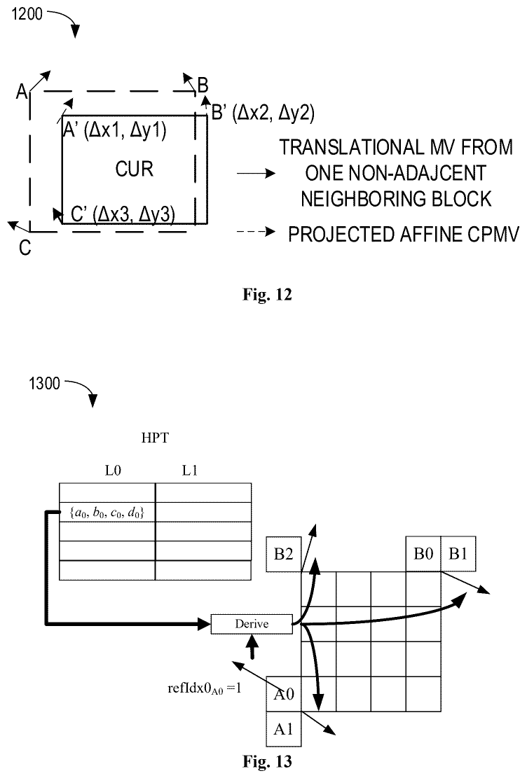

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in the (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. FIG. 12 illustrates a diagram 1200 from non-adjacent neighbors to constructed affine merge candidates. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) \qquad ( 3 )$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat (RefListcur, RefIdxcur) in a way similar to HMVP table updating.

FIG. 13 illustrates an example diagram 1300 of generating an HAPC. A history-affine-parameter-based candidate (HAPC) is derived from a neighbouring 4×4 block denoted as A0, A1, B0, B1 or B2 in FIG. 13 and a set of affine parameters stored in a corresponding entry in HPT. The MV of a neighbouring 4×4 block served as the base MV.

In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows how to derive an HAPC from block A0. The affine parameters {a0, b0, c0, d0} are directly fetched from one entry of category HPTIdx (RefListA0, refIdx0A0) in HPT. The affine parameters from HPT, with the center position of A0 as the base position, and the MV of block A0 as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

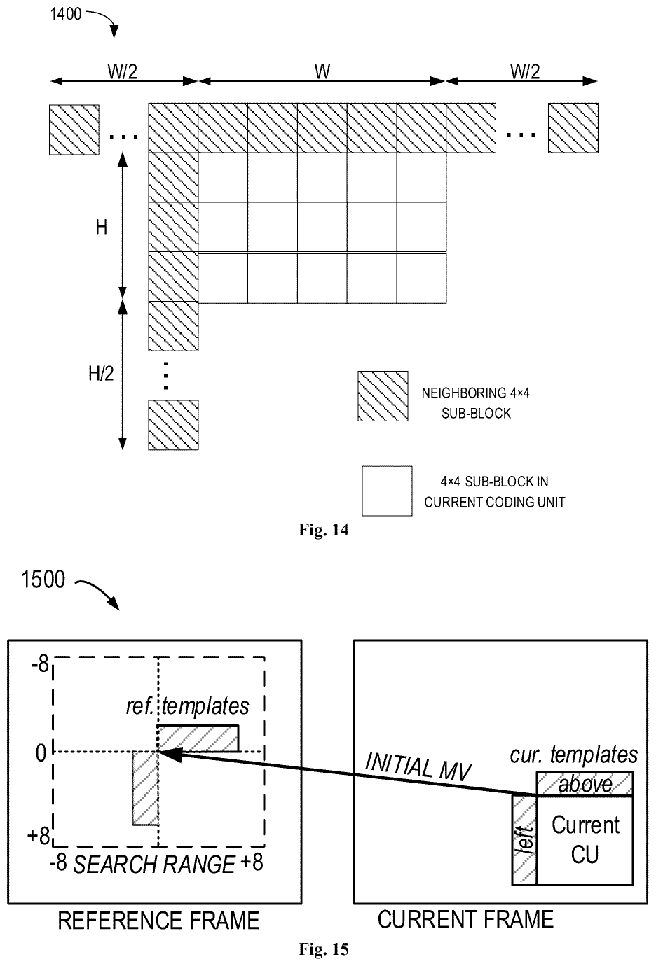

The previously coded affine CU can be identified from scanning through non-adjacent positions and the affine HMVP table. FIG. 14 illustrates an illustration 1400 of regression based affine merge candidate derivation. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

### 2.3. Template Matching Merge/AMVP Mode in ECM

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 15 illustrates a diagram 1500 of template matching performing on a search area around initial MV. As illustrated in FIG. 15, a better MV is to be searched around the initial motion of the current CU within a [−8, +8]-pel search range.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

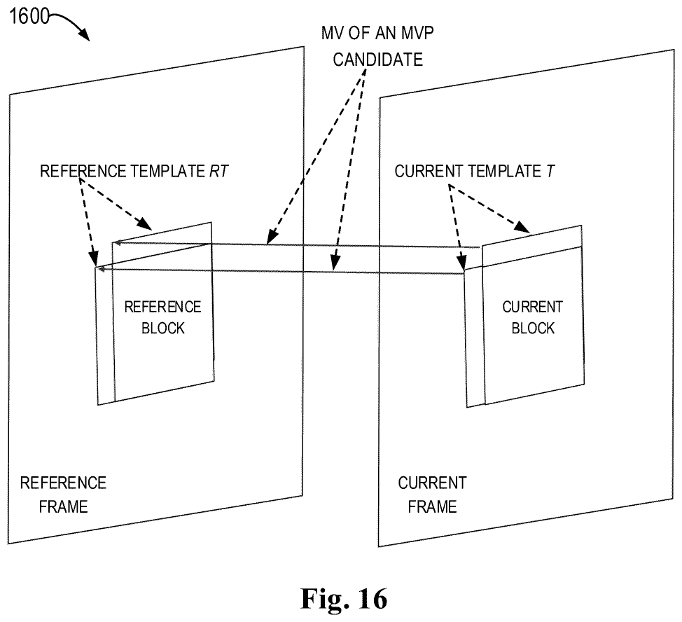

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered. The template matching cost is measured by the sum of absolute differences (SAD) between samples of a template of the current block and their corresponding reference template. FIG. 16 illustrates a diagram 1600 of template and the corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction.

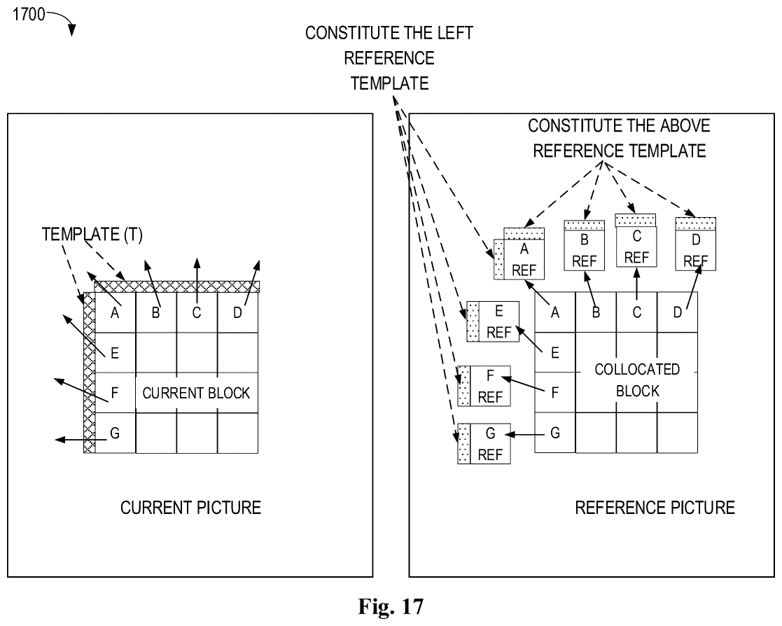

For subblock-based merge candidates with subblock size equal to Wsub*Hsub, the above template comprises several sub-templates with the size of Wsub×K, and the left template comprises several sub-templates with the size of K×Hsub. FIG. 17 illustrates a diagram 1700 of template and reference template for block with sub-block motion using the motion information of the subblocks of current block. As shown in FIG. 17. the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTVMP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

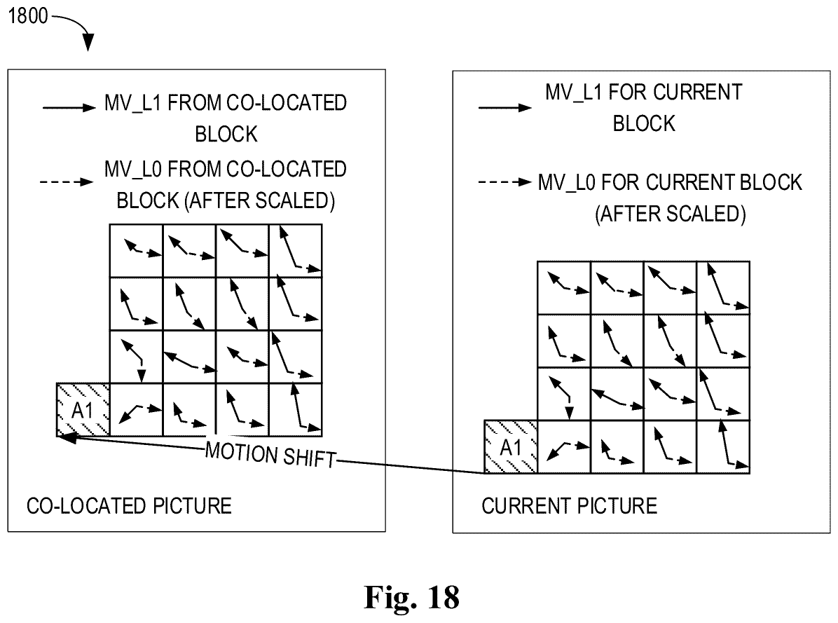

FIG. 18 illustrates the derivation process 1800 of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero mv will be used as motion shift.

Once the motion shift is determined, the specified regions in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

FIG. 18 illustrates deriving sub-CU motion field obtained by applying a motion shift based on the neighboring motion information.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 3. Problems

CPMV is critical for Affine motion compensation since it provides basic motion information for all the sub-blocks within the block. In existing CPMV derivation methods, however, the CPMV of the current block is estimated as the MV of an already-coded block, which may not guarantee the coherence with the true motion. Therefore, a CPMV refinement method is highly desired to reduce the deviation between the estimated CPMV and the true motion.

### 4. Detailed solutions

In this disclosure, it is proposed to refine Affine CPMV with template matching. For a given Affine candidate in Affine candidate list, the CPMV may be further refined with template matching, and the refined Affine candidate is then used to derive sub-block or pixel level Affine motion information for the current block. The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

The terms ‘Affine block’ may represent a block coded with Affine merge, Affine AMVP or any other Affine variant mode (i.e., Affine MMVD etc), which may be described by motion information of two control point (4-parameter) or three control point motion vectors (6-parameter). The terms ‘CPMV’ may represent the motion information of an Affine block at top-left, top-right and/or bottom-left corners. The term ‘template’ may represent a reconstructed region that can be used to refine the CPMV, which may represent either ‘separate template’ or ‘unified template’. Here a ‘separate template’ may represent a reconstructed region that can be used to refine individual CPMV, i.e., specific one(s) of top-left, top-right and/or bottom-left corners, while a ‘unified template’ may represent a reconstructed region that can be used to refine all or arbitrary CPMV(s) for a block. The term ‘template matching cost’ or ‘TM cost’ may represent either matching cost of a separate template or a unified template.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.

1. In one example, affine motion compensation may be refined by using previously decoded samples.
a) In one example, at least one CPMV may be refined.
b) In one example, at least one MV of one subblock of affine motion compensation may be refined.
c) In one example, at least one affine parameter (such as a, b, c, d, e, f) may be refined.
d) In one example, previously decoded samples may be a template of the current block.
e) In one example, previously decoded samples may be a template of the reference block.
f) In one example, template represents a reconstructed region that can be used to refine the CPMV.
g) In one example, for an Affine-coded block, different separate templates may be used for different control points.
   i. In one example, for a control point, the corresponding separate template may comprise the samples from the adjacent and/or non-adjacent positions in the already-reconstructed region.
      1) In one example, the separate templates for all the control points are collected from adjacent reconstructed region.
      2) In one example, the separate template samples for some control points are collected from the adjacent reconstructed region of the current block, while for the rest control points, the temple samples are collected from non-adjacent reconstructed region.
         a) In one example, specifically, the template samples for left-top corner are collected from non-adjacent region, while for right-top and/or left-bottom corners, the temple samples are collected from adjacent region.
      3) In one example, both adjacent and non-adjacent samples are used for certain control points.
   ii. In one example, for different control points, the shape of the separate templates may be different.
      1) In one example, for certain control points, L-shape (e.g., comprising both above and left neighbouring samples) separate template is used.
      2) In one example, for certain control points, I-shape or ‘-’ shape template (e.g., comprising either left or above (but not both) neighbouring samples) may be used.
   iii. In one example, which shape of template is used for a CPMV refinement may be based on the position/location of the control point.
      1) In one example, CPMV at the top-left corner of the current video unit may use a L-shape template (e.g., comprising both above and left neighbouring samples).
      2) In one example, CPMV at the top-right corner of the current video unit may use a ‘-’ shape template (e.g., comprising above neighbouring samples only).
      3) In one example, CPMV at the top-left corner of the current video unit may use a I-shape template (e.g., comprising left neighbouring samples only).
      4) In one example, for a certain CPMV, the shapes of templates in the current picture and reference picture are same.
         a) For example, as depicted in FIG. 16, the template of a CPMV may refer to a group of neighbouring samples in the current picture (e.g., templates in the current picture) and a second group of neighbouring samples in a reference picture (e.g., templates in the reference picture).
   iv. In one example, for different control points, the number of the samples used in the template may be different.
      1) Alternatively, the number of the sample used for different control points are the same for an Affine block.
      2) For different control points, the lines (or rows or columns) of the samples used in the template may be different.
h) In one example, a unified template is used during the CPMV refinement.
   i. In one example, the TM cost associated with the unified template is used to determine the MV shift value.
   ii. In one example, the TM cost associated with the unified template is used to determine the CPMV combination.
   iii. In one example, a unified template may comprise all or partial adjacent samples of the whole block, i.e. as shown in FIG. 16.
i) A template may only comprise samples from one component such as luma, or from multiple components such as luma and chroma.
j) In one example, for arbitrary template, a reference template region with the same shape may be located with a MV, as shown in FIG. 16.
k) In one example, a template may not necessarily contain all the pixels in a certain region, it may contain part of the pixels in the specified region.

2. When constructing an Affine candidate list, CPMV refinement may be firstly performed to a potential affine candidate, then the refined candidate is inserted into the Affine candidate list.
a) In one example, alternatively, CPMV refinement is conducted after the Affine candidate list is constructed.
   i. In one example, only the Affine candidate(s) with specific index(es) need to perform CPMV refinement.

3. In one example, a first Affine candidate list is constructed firstly, followed by a second Affine candidate list construction process.
a) For example, the input of the second Affine candidate list generation may be based on the output of the first Affine candidate list generation.
b) For example, the first Affine candidate list may be constructed without CPMV refinement.
c) For example, the second Affine candidate list may be generated by applying CPMV refinement on the CPMV candidates in the first Affine candidate list.
   i. For example, at least one CPMV candidate in the first Affine candidate list may be refined.
   ii. Alternatively, more than one CPMV candidates in the Affine candidate list may be refined.
   iii. For example, the CPMV refinement may be based on TM.
d) For example, the first Affine candidate list may be constructed with a candidate reordering process.
   i. For example, the reordering process may be based on TM.
e) For example, the second Affine candidate list may be constructed without any candidate reordering process.
   f) For example, different pruning rules may be used in the first pruning and the second pruning.
      i. For example, the first Affine candidate list generation may be applied associated with a first pruning method.
      ii. For example, the second Affine candidate list generation may be applied associated with a second pruning method.
      iii. For example, the threshold for motion similarity checks in the first and second pruning methods may be different.
      iv. For example, a block dimension (e.g., block width and/or height) based threshold may be used in the second pruning method.
      v. For example, alternatively, a fixed threshold may be used in the second pruning method.

4. For a given Affine candidate, some or all of the CPMVs may be refined based on TM, then the refined CPMVs are used to derive the Affine motion information for the current block and/or sub-block(s).
a) In one example, both integer and fractional precision may be used to refine the control points.
   i. In one example, only integer precision is used to refine the control point, and fractional precision searching is skipped.
      1) In one example, whether fractional precision search is needed depends on the results of integer precision search.
   ii. In one example, it is proposed to use a specific interpolation filter to generate reference templates for motion vectors pointing to fractional positions.
      1) In one example, a simplified interpolation filter may be applied.
      2) In one example, the simplified interpolation filter can be 2-tap bilinear, alternatively, it can also be 4-tap, 6-tap or 8-tap filter that belongs to DCT, DST, Lanczos or any other interpolation types.
      3) In one example, a more complex interpolation filter (e.g., with longer filter taps) may be applied.
   iii. In one example, whether to use above methods (e.g., integer precision, different interpolation filters) or not and/or how to use above methods can be signalled in the bitstream (such as in SPS, PPS, picture header, slice header, CTU, CU, etc.) or determined on-the-fly according to decoded information.
      1) In one example, which method to be applied may be dependent on the coding tool.
      2) In one example, which method to be applied may be dependent on block dimension.
b) In one example, different control points are respectively refined, which means the MV shift values (i.e., the difference between an initial CPMV and the corresponding refined CPMV) may be different for different control points.
   i. In one example, all or some of the control points may first be respectively refined by TM, then one combination of control points is determined by looping over all or some of the combinations (i.e. M (such as M=4) combinations for 4-parameter model, —N (such as N=8) combinations for 6-parameter model) of CPMVs before and after refinement, and one set of CPMVs that minimize the TM cost of the current block is derived.
      1) In one example, in above case, all or some of the control points may first be refined by the respective separate templates.
      2) In one example, for each combination of CPMVs, the sub-block level motion information is calculated for the boundary sub-blocks, then the unified TM cost is calculated in accordance with the method described in section 2.4 and FIG. 17. The optimal combination which yields the least TM cost is selected as the refined Affine candidate.
         a) In one example, only partial boundary sub-blocks need to calculate the TM cost.
      3) In one example, alternatively, there is no need to loop over all the combinations, and the combination of which the control points are all refined by TM is directly served as the refined Affine candidate.
      4) In one example, when the refined Affine candidate is derived, a 2^{nd} pass control point refinement may be performed to further refine each control point.
         a) In one example, each CPMV is further iteratively refined to minimize the TM cost of the current block. In each iteration, one CPMV is refined while the others are fixed.
c) In one example, alternatively, multiple control points are simultaneously refined, where a same MV shift value is shared for all or multiple control points.
   i. In one example, all or partial MV shift values in a given MV shift set are traversed one by one. The MV shift value being traversed is assigned to all or multiple CPMVs, then the motion information of the boundary sub-blocks associated with the refined CPMVs are calculated, and the TM cost is formulated accordingly. In this process, the one that yields the least TM cost is determined as the best motion shift value, which may be finally used to refined the CPMVs.

5. The CPMV refinement may be used with regression based Affine candidate derivation method.
a) In one example, after all or some of the CPMVs are refined with TM (yielding Affine_model_TM), the motion information of the boundary sub-blocks associated with Affine_model_TM are derived, which is then fed to a regression model to output a new Affine model (termed as Affine_model_R). Then the TM cost of boundary sub-blocks with Affine_model_TM and Affine_model_R are respectively calculated and compared. And the one with less TM cost is determined as the ultimate refined Affine candidate.
   i. In one example, all or some of the CPMVs may firstly perform integer precision TM refinement (yielding Affine_model_TM_I), then perform fractional precision TM refinement (yielding Affine_model_TM_F). And the motion information of the boundary sub-blocks associated with Affine_model_TM_I is derived, which is then fed to a regression model to output a new Affine model (Affine_model_R). Finally, the TM cost of boundary sub-blocks with Affine_model_TM_F and Affine_model_R are calculated and compared, and the one with less TM cost is determined as the ultimate refined Affine candidate.
   ii. In one example, only partial sub-blocks may need to calculate TM cost to generate Affine_model_TM, Affine_model_TM_I and/or Affine_model_TM_F.

6. In one example, TM-based refinement may be applied to affine merge or affine AMVP (affine inter).
a) In one example, the MVP(s) of affine AMVP may be refined based on TM.
   i. Alternatively, the MVP(s) of affine AMVP may be refined based on DMVR.

7. In one example, TM-based refinement may be applied to an affine-coded block together with DMVR-based refinement.
a) In one example, TM-based refinement may be applied before DMVR.
b) In one example, TM-based refinement may be applied after DMVR.
c) Alternatively, TM-based refinement may be applied to an affine-coded block exclusively with DMVR-based refinement.

8. In one example, derivation of TM cost may depend on whether the block is bi-predicted or uni-predicted.
a) If the block is bi-predicted, TM cost may be derived based on bi-prediction on TM.
   i. In one example, let TMref0 and TMref1 be the reference TM associated with the List0 and List1 respectively, then the ultimate reference TM (TMbi) may be derived as:

$$TMbi = a * TMref 0 + ( 1 - a ) * TMref 1.$$

1) In one example, a equals to 0.5.
2) In one example, a is determined based on BCW index.
3) In one example, TMref0 is generated based on the CPMVs in List 0, and/or TMref1 is generated based on the CPMVs in List 1.
b) Alternatively, if the block is bi-predicted, TM cost may be calculated for List0 and List1 separately.

9. In one example, the refinement of CPMVs may be done in an iterative way.
a) For example, in one step of refinement, one CPMV is refined while others are fixed.
b) In one example, the already refined CPMV(s) may be used when a subsequent CPMV is to be refined.
   i. In one example, alternatively, the CPMV before refinement is used when the subsequent CPMVs are to be refined.
c) In one example, the refinement of CPMVs may be done in an iterative way for bi-predicted blocks.
   i. In one example, the CPMVs associated with List K (K=0 or 1) may be firstly refined, then the CPMVs associated with List (1-K) are refined.
      1) Whether to and/or how to refine the CPMVs in a later List (1-K) may be determined based on the refined CPMVs of a former List K.
   ii. In one example, the CPMVs associated with List 0 and List 1 may be separately refined.
      1) In one example, specifically, when the CPMVs in List K (K=0 or 1) are being refined, for each searching step, uni-directional reference TM in List K is generated based on the corresponding CPMVs, and TM cost is hereby calculated to determine the best MV shift value.
   iii. In one example, alternatively, the CPMVs associated with List 0 and List 1 may be jointly refined.
      1) In one example, specifically, when the CPMVs in List K (K=0 or 1) are being refined, for each searching step, bi-directional reference TM is generated based on the CPMV information of both List (as described in Bullet 8). The one yielding the least TM cost is determine as the best MV shift value.

10. Multiple rounds of refinement may be conducted to CPMVs.
a) In one example, all or partial CPMVs may be refined in each round of refinement.
b) In one example, all or partial CPMVs may already be refined in a former round refinement, then a later round is conducted to further refine the CPMVs.

11. Whether to and/or how to refine the CPMVs based on TM may be determined based on the prediction direction of the current block.
a) In one example, the CPMVs may need to be refined by TM only when the current block is uni- predicted.
b) In one example, the CPMVs may need to be refined by TM only when the current block is bi-predicted.
c) In one example, the CPMVs may always need to be refined by TM no matter whether the current block is bi-predicted or not.

12. The disclosed methods may be applied to MHP (Multiple hypothesis prediction) coded block if Affine prediction is used as a hypothesis.

13. Whether to and/or how to apply the disclosed methods above may be determined based on syntax element(s).
a) For example, at least one syntax element is signalled in the bitstream.
b) For example, whether to and/or how to apply the disclosed methods may be signalled at sequence level/group of pictures level/picture level/slice level/tile group level, such as in sequence header/picture header/SPS/VPS/DPS/DCI/PPS/APS/slice header/tile group header.
c) For example, whether to and/or how to apply the disclosed methods may be signalled at PB/TB/CB/PU/TU/CU/VPDU/CTU/CTU row/slice/tile/sub-picture/other kinds of region contain more than one sample or pixel.
d) For example, whether to and/or how to apply the disclosed methods above may be dependent on coded information, such as block size, colour format, single/dual tree partitioning, colour component, slice/picture type.
e) For example, whether a syntax element (i.e., indicating if TM refinement is applied to CPMVs) is signalled or not may be determined based on another syntax element.

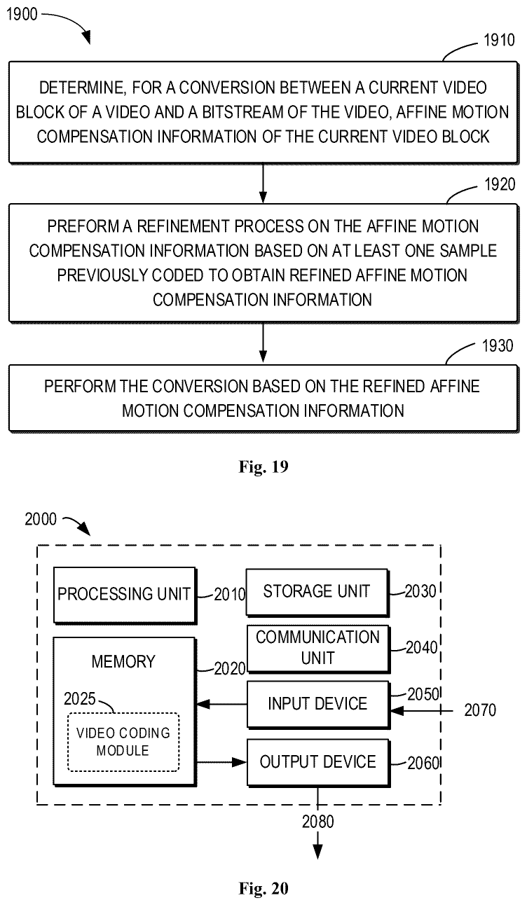

FIG. 19 illustrates a flowchart of a method 1900 for video processing in accordance with embodiments of the present disclosure. The method 1900 may be implemented during a conversion between a current video block of a video and a bitstream of the video.

At block 1910, affine motion compensation information of the current video block is determined. At block 1920, a refinement process is performed on the affine motion compensation information based on at least one sample previously coded to obtain refined affine motion compensation information. For example, the affine motion compensation may be refined by using previously decoded samples. At block 1930, the conversion is performed based on the refined affine motion compensation information.

The method 1900 enables refining the affine motion compensation information. For example, control point motion vector (CPMV) used in affine motion compensation can be refined. In this way, the coding effectiveness and coding efficiency can be improved.

In some embodiments, the affine motion compensation information comprises at least one of: a control point motion vector of the current video block, a motion vector (MV) of a subblock of the current video block, or an affine parameter for an affine coding mode. For example, at least one CPMV may be refined. At least one MV of a subblock of affine motion compensation may be refined. At least one affine parameter (such as a, b, c. d. e. f) may be refined.

In some embodiments, the at least one sample comprises at least one of: samples in a first template of the current video block, or samples in a second template of a reference block of the current video block.

In some embodiments, at least one of the first template or the second template comprises a reconstructed region, and samples in the reconstructed region is used to refine a control point motion vector of the current video block.

In some embodiments, the current video block is affine coded, a plurality of control points is associated with the current video block, and a plurality of templates is used for refining the plurality of control points.

In some embodiments, for a first control point of the plurality of control points, a corresponding template in the plurality of templates comprises samples from at least one of: an adjacent position in a reconstructed region associated with the current video block, or a non-adjacent position in the reconstructed region.

In some embodiments, the plurality of templates comprises samples in a reconstructed region adjacent to the current video block.

In some embodiments, a first template of a first control point of the plurality of control points comprises samples in a first reconstructed region adjacent to the current video block, and a second template of a second control point of the plurality of control points comprises samples in a second reconstructed region non-adjacent to the current video block.

In some embodiments, the first control point is located at at least one of: a right-top corner of the current video block, or a left-bottom corner of the current video block, and the second control point is located at a left-top corner of the current video block.

In some embodiments, a first template of a first control point of the plurality of control points comprises samples in a first reconstructed region adjacent to the current video block and samples in a second reconstructed region non-adjacent to the current video block.

In some embodiments, a first shape of a first template of a first control point in the plurality of control points is different from a second shape of a second template of a second control point in the plurality of control points.

In some embodiments, the first shape comprises an L-shape, and the first template comprises above and left neighboring samples of the current video block, and/or the second shape comprises an I-shape or a horizontal line shape such as “-” shape, and the second template comprises one of: left neighboring samples of the current video block, or above neighboring samples of the current video block.

In some embodiments, a shape of a template in the plurality of templates is determined based on a position of a correspond control point.

In some embodiments, for a first control point at a top-left corner of the current video block, a shape of a corresponding template of the first control point is an L-shape, and the corresponding template comprises above and left neighboring samples of the current video block.

In some embodiments, for a second control point at a top-right corner of the current video block, a shape of a corresponding template of the second control point is a horizontal line shape such as “-” shape, and the corresponding template comprises above neighboring samples of the current video block.

In some embodiments, for a first control point at a top-left corner of the current video block, a shape of a corresponding template of the first control point is an I-shape, and the corresponding template comprises left neighboring samples of the current video block.

In some embodiments, for a control point of the current video block, a shape of a first template in a current picture is the same with a shape of a second template in a reference picture, the first template and the second template being associated with the control point.

In some embodiments, a template of the control point comprises neighboring samples in the first template and neighboring samples in the second template.

In some embodiments, the second template is located based on a motion vector of the current video block.

In some embodiments, a first template of a first control point comprises a first number of samples, and a second template of a second control point comprises a second number of samples, the first number being different from the second number.

In some embodiments, a first line of samples in the first template is different from a second line of samples in the second template, a line of samples comprising a row of samples or a column of samples. The line of samples may be a row of samples or a column of samples.

In some embodiments, a first template of a first control point comprises a first number of samples, and a second template of a second control point comprises a second number of samples, the first number being the same with the second number.

In some embodiments, performing the refinement process comprises: determining a unified template associated with the current video block; determining a template matching cost of the unified template; and performing the refinement process based on the template matching cost.

In some embodiments, a motion vector shift value is determined based on the template matching cost.

In some embodiments, a control point motion vector combination is determined based on the template matching cost.

In some embodiments, the unified template comprises at least a partial of adjacent samples of the current video block.

In some embodiments, a template of the current video block comprises samples of at least one of: a luma component, or a chroma component.

In some embodiments, a template of the current video block comprises at least a partial of pixels in a region.

In some embodiments, performing the refinement process comprises: performing a control point motion vector refinement process on at least one affine candidate of the current video block; and determining an affine candidate list of the current video block by adding the at least one refined affine candidate into the affine candidate list.

In some embodiments, performing the refinement process comprises: performing a control point motion vector refinement process on at least one affine candidate in the affine candidate list.

In some embodiments, the control point motion vector refinement process is performed on an affine candidate with an index.

In some embodiments, the method 1900 further comprises: determining a first affine candidate list of the current video block; and determining a second affine candidate list of the current video block.

In some embodiments, the first affine candidate list is determined without the refinement process.

In some embodiments, the second affine candidate list is determined based on the first affine candidate list.

In some embodiments, determining the second affine candidate list comprises: determining a candidate in the second affine candidate list by performing a control point motion vector refinement process on at least one control point motion vector in the first affine candidate list.

In some embodiments, the control point motion vector refinement process is based on template matching.

In some embodiments, the first affine candidate list is determined based on a candidate reordering process.

In some embodiments, the candidate reordering process is based on template matching.

In some embodiments, the second affine candidate list is determined without a candidate reordering process.

In some embodiments, the first affine candidate list is determined with a first pruning process, and the second affine candidate list is determined with a second pruning process, a first pruning rule of the first pruning process being different from a second pruning rule of the second pruning process.

In some embodiments, a first threshold for motion similarity check in the first pruning process is different from a second threshold for motion similarity check in the second pruning process.

In some embodiments, the second threshold is based on a block dimension of the current video block.

In some embodiments, the second threshold is a fixed value.

In some embodiments, preforming the refinement process comprises: performing the refinement process on at least one control point motion vector of an affine candidate of the current video block based on template matching; and wherein performing the conversion comprises: determining, based on the at least one refined control point motion vector, affine motion information for at least one of the current video block or a subblock of the current video block.

In some embodiments, at least one of an integer precision or a fractional precision is used in the refinement process.

In some embodiments, an integer precision is used in the refinement process, and a fractional precision searching is skipped.

In some embodiments, performing of a fractional precision searching on the affine candidate is based on a result of an integer precision search.

In some embodiments, the factional precision is used in the refinement process, and an interpolation filter is used to determine at least one reference template for at least one motion vector pointing to at least one fractional position.

In some embodiments, the interpolation filter comprises a simplified interpolation filter.

In some embodiments, the interpolation filter comprises at least one of: a 2-tap bilinear filter, a 4-tap, 6-tap or 8-tap discrete cosine transform filter, a 4-tap, 6-tap or 8-tap discrete sine transform filter, or a 4-tap, 6-tap or 8-tap Lanczos filter.

In some embodiments, the interpolation filter comprises an interpolation filter with a filter taps longer than a threshold length.

In some embodiments, whether to and/or how to use the method is determined based on the bitstream, or coding information of the current video block.

In some embodiments, whether to and/or how to use the method is included in at least one of: a sequence parameter set (SPS), a picture parameter set (PPS), a picture header, a slice header, a coding tree unit (CTU), or a coding unit (CU).

In some embodiments, the coding information comprises at least one of: a coding tool applied to the current video block, or a block dimension of the current video block.

In some embodiments, preforming the refinement process comprises: performing the refinement process on motion information of a plurality of control points based on a target motion vector shift value, the target motion vector shift value being a difference between a control point motion vector and a corresponding refined control point motion vector.

In some embodiments, traversing a given motion vector shift value of the plurality of motion vector shift values comprises: determining a refined control point motion vector based on the given motion vector shift value and the at least one control point motion vector; determining motion information of at least one boundary subblock associated with the at least one refined control point motion vector; and determining a template matching cost corresponding to the given motion vector shift value based on the motion information; and determining the target motion vector shift value based on a plurality of template matching costs corresponding to the plurality of motion vector shift values. For example, the template matching cost may be determined by using a method described in section 2.4 or a method described with respect to FIG. 17.

In some embodiments, a first motion vector shift value associated with a first control point of the current video block is different from a second motion vector shift value associated with a second control point of the current video block, a motion vector shift value being a difference between a control point motion vector and a corresponding refined control point motion vector.

In some embodiments, the method 1900 further comprises: determining a plurality of candidate control point motion vectors of a plurality of control points associated with the current video block; determining a plurality of refined control point motion vectors based on the plurality of candidate control point motion vectors; and determining a target control point motion vector combination at least based on the plurality of refined control point motion vectors, the target control point motion vector being used in the refinement process.

In some embodiments, the target control point motion vector combination comprises the plurality of refined control point motion vectors.

In some embodiments, determining the target control point motion vector combination comprises: determining a plurality of control point motion vector combination, each control point motion vector combination comprising respective control point motion vectors of the plurality of control points, a respective control point motion vector comprising a candidate control point motion vector or a refined control point motion vector; determining a plurality of template matching costs based on the plurality of control point motion vector combinations; and determining a target control point motion vector combination based on the plurality of template matching costs, the target control point motion vector being used in the refinement process.

In some embodiments, at least a partial of the plurality of control points is refined based on respective templates of the plurality of control points.

In some embodiments, determining the plurality of template matching costs comprises: for a control point motion vector combination in the plurality of control point motion vector combinations, determining subblock level motion information of at least one boundary subblock of the current video block; and determining a corresponding template matching cost based on the subblock level motion information.

In some embodiments, the at least one boundary subblock comprises a partial of boundary subblocks of the current video block.

In some embodiments, the target control point motion vector combination is associated with a minimum template matching cost, and the target control point motion vector combination is determined as a refined affine candidate of the current video block.

In some embodiments, a second pass of control point refinement process is performed on the refined affine candidate to further refine each control point.

In some embodiments, each control point motion vector of the refined affine candidate is further iteratively refined to minimize a template matching cost of the current video block.

In some embodiments, in a given iteration, a control point motion vector is refined, and other control point motion vectors are fixed.

In some embodiments, the refinement process is used with a regression based affine candidate derivation.

In some embodiments, performing the refinement process comprises: performing the refinement process on at least a partial of control point motion vectors of the current video block based on template matching to obtain a first refined affine candidate, and wherein the method further comprising: determining motion information of at least one boundary subblock associated with the first refined affine candidate; determining a second affine candidate based on the motion information and a regression model; and determining a target affine candidate by comparing a first template matching cost of at least one boundary subblock with the first refined affine candidate and a second template matching cost of at least one boundary subblock with the second affine candidate.

In some embodiments, after all or some of the CPMVs are refined with TM (yielding Affine_model_TM), the motion information of the boundary sub-blocks associated with Affine_model_TM are derived, which is then fed to a regression model to output a new Affine model (termed as Affine_model_R). Then the TM cost of boundary sub-blocks with Affine_model_TM and Affine_model_R are respectively calculated and compared. The one with less TM cost is determined as the ultimate refined Affine candidate.

In some embodiments, performing the refinement process comprises: performing an integer precision refinement process on at least a partial of control point motion vectors of the current video block based on template matching to obtain a first refined affine candidate, and performing a fractional precision refinement process on the first refined affine candidate to obtain a second refined affine candidate; and wherein the method further comprising: determining motion information of the at least one boundary subblock associated with the first refined affine candidate; determining a third affine candidate based on the motion information and a regression model; and determining a target affine candidate by comparing a first template matching cost of the at least one boundary subblock with the second refined affine candidate and a second template matching cost of the at least one boundary subblock with the third affine candidate.

In some embodiments, all or some of the CPMVs may firstly perform integer precision TM refinement (yielding Affine_model_TM_I), then perform fractional precision TM refinement (yielding Affine_model_TM_F). And the motion information of the boundary sub-blocks associated with Affine_model_TM_I is derived, which is then fed to a regression model to output a new Affine model (Affine_model_R). Finally, the TM cost of boundary sub-blocks with Affine_model_TM_F and Affine_model_R are calculated and compared, and the one with less TM cost is determined as the ultimate refined Affine candidate.

In some embodiments, the at least one subblock comprises a partial of boundary subblocks of the current video block. For example, only partial sub-blocks may need to calculate TM cost to generate Affine_model_TM, Affine_model_TM_I and/or Affine_model_TM_F.

In some embodiments, the refinement process is based on template matching, and the refinement process is applied to at least one of: an affine merge candidate, or an affine advanced motion vector prediction (AMVP), or an affine inter prediction.

In some embodiments, a motion vector prediction (MVP) of the affine AMVP is refined based on at least one of template matching or decoder side motion vector refinement (DMVR).

In some embodiments, the current video block is affine coded, and a template matching based refinement process is applied to the current video block together with a decoder side motion vector refinement (DMVR) based refinement process.

In some embodiments, the template matching based refinement process is applied before or after the DMVR based refinement process.

In some embodiments, the current video block is affine coded without being applied a decoder side motion vector refinement (DMVR) based refinement process, and a template matching based refinement process is applied to the current video block.

In some embodiments, the method 1900 further comprises: determining a template matching cost of the current video block based on whether the current video block is bi-predicted or uni-predicted.

In some embodiments, the current video block is bi-predicted, and the template matching cost is determined based on a bi-prediction on template matching.

In some embodiments, the template matching cost is determined based on a weighted sum of a first reference template matching cost associated with a first reference list and a second reference template matching cost associated with a second reference list. For example, let TMref0 and TMref1 be the reference TM associated with the List0 and List1 respectively, then the ultimate reference TM (TMbi) may be derived as: TMbi=a*TMref0+(1-a)*TMref1, and a denotes a first weight of the first reference TM cost.

In some embodiments, a sum of a first weight of the first reference template matching cost and a second weight of the second reference template matching cost is one.

In some embodiments, the first weight is 0.5.

In some embodiments, the first weight is determined based on an index of a bi-prediction with coding unit level weight (BCW).

In some embodiments, the first reference template matching cost is determined based on at least one control point motion vector in the first reference list, and the second reference template matching cost is determined based on at least one control point motion vector in the second reference list.

In some embodiments, the current video block is bi-predicted, and a first template matching cost is determined for a first reference list and a second template matching cost is determined for a second reference list.

In some embodiments, the refinement process on at least one control point motion vector of the current video block is performed iteratively.

In some embodiments, in a step of the refinement process, a first control point motion vector is refined, and other control point motion vectors are fixed.

In some embodiments, a first refined control point motion vector is used in a subsequent refinement for a second control point motion vector.

In some embodiments, a first control point motion vector without refining is used in a subsequent refinement for a second control point motion vector.

In some embodiments, the current video block is bi-predicted.

In some embodiments, a first control point motion vector associated with a first reference list is refined before refining a second control point motion vector associated with a second reference list.

In some embodiments, whether to and/or how to refine the second control point motion vector in the second reference list is determined based on the refined first control point motion vector.

In some embodiments, a first control point motion vector associated with a first reference list and a second control point motion vector associated with a second reference list are refined separately.

In some embodiments, during refining the first control point motion vector, for a searching step, a uni-directional reference template matching in the first reference list is determined based on the first control point motion vector, a template matching cost is determined based on the uni-directional reference template matching to obtain a motion vector shift value.

In some embodiments, a first control point motion vector associated with a first reference list and a second control point motion vector associated with a second reference list are jointly refined.

In some embodiments, during refining the first control point motion vector, for a searching step, a bi-directional reference template matching is determined based on the first control point motion vector and the second control point motion vector, a template matching cost is determined based on the bi-directional reference template matching to obtain a motion vector shift value.

In some embodiments, performing the refinement process comprises: performing a plurality of rounds of the refinement process to a plurality of control point motion vectors of the current video block.

In some embodiments, at least a partial of the plurality of control point motion vectors is refined in a round of the plurality of rounds of the refinement process.

In some embodiments, at least a partial of the plurality of control point motion vectors is refined in a first round of the plurality of rounds of the refinement process, and a second round of the refinement process is further performed on the at least partial of the refined plurality of control point motion vectors.

In some embodiments, whether to and/or how to refine at least one control point motion vector of the current video block based on template matching is determined based on a prediction direction of the current video block.

In some embodiments, the current video block is uni-predicted, and the at least one control point motion vector is to be refined based on template matching.

In some embodiments, the current video block is bi-predicted, and the at least one control point motion vector is to be refined based on template matching.

In some embodiments, the current video block is bi-predicted or uni-predicted, and the at least one control point motion vector is to be refined based on template matching.

In some embodiments, an affine prediction is used as a hypothesis of the current video block coded with multiple hypothesis prediction (MHP).

In some embodiments, whether to and/or how to apply the method is based on a syntax element in the bitstream.

In some embodiments, the syntax element is at at least one of: a sequence level, a group of pictures level, a picture level, a slice level, or a tile group level.

In some embodiments, the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

In some embodiments, the syntax element is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

In some embodiments, whether to and/or how to apply the method is determined based on coding information of the current video block.

In some embodiments, the coding information comprises at least one of: a block size of the current video block, a color format of the current video block, a single or dual tree partitioning of the current video block, a color component of the current video block, a slice type of the current video block, or a picture type of the current video block.

In some embodiments, whether a first syntax element indicating if a template matching based refinement process is applied to a control point motion vector of the current video block is determined based on a second syntax element.

In some embodiments, the conversion includes encoding the current video block into the bitstream.

In some embodiments, the conversion includes decoding the current video block from the bitstream.

According to further embodiments of the present disclosure, a non-transitory computer-readable recording medium is provided. The non-transitory computer-readable recording medium stores a bitstream of a video which is generated by a method performed by an apparatus for video processing. In the method, affine motion compensation information of a current video block of the video is determined. A refinement process is performed on the affine motion compensation information based on at least one sample previously coded to obtain refined affine motion compensation information. The bitstream is generated based on the refined affine motion compensation information.

According to still further embodiments of the present disclosure, a method for storing bitstream of a video is provided. In the method, affine motion compensation information of a current video block of the video is determined. A refinement process is performed on the affine motion compensation information based on at least one sample previously coded to obtain refined affine motion compensation information. The bitstream is generated based on the refined affine motion compensation information. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, affine motion compensation information of the current video block; preforming a refinement process on the affine motion compensation information based on at least one sample previously coded to obtain refined affine motion compensation information; and performing the conversion based on the refined affine motion compensation information.

Clause 2. The method of clause 1, wherein the affine motion compensation information comprises at least one of: a control point motion vector of the current video block, a motion vector of a subblock of the current video block, or an affine parameter for an affine coding mode.

Clause 3. The method of clause 1 or 2, wherein the at least one sample comprises at least one of: samples in a first template of the current video block, or samples in a second template of a reference block of the current video block.

Clause 4. The method of clause 3, wherein at least one of the first template or the second template comprises a reconstructed region, and samples in the reconstructed region is used to refine a control point motion vector of the current video block.

Clause 5. The method of clause 3 or 4, wherein the current video block is affine coded, a plurality of control points is associated with the current video block, and a plurality of templates is used for refining the plurality of control points.

Clause 6. The method of clause 5, wherein for a first control point of the plurality of control points, a corresponding template in the plurality of templates comprises samples from at least one of: an adjacent position in a reconstructed region associated with the current video block, or a non-adjacent position in the reconstructed region.

Clause 7. The method of clause 5, wherein the plurality of templates comprises samples in a reconstructed region adjacent to the current video block.

Clause 8. The method of clause 5, wherein a first template of a first control point of the plurality of control points comprises samples in a first reconstructed region adjacent to the current video block, and a second template of a second control point of the plurality of control points comprises samples in a second reconstructed region non-adjacent to the current video block.

Clause 9. The method of clause 8, wherein the first control point is located at at least one of: a right-top corner of the current video block, or a left-bottom corner of the current video block, and the second control point is located at a left-top corner of the current video block.

Clause 10. The method of clause 5, wherein a first template of a first control point of the plurality of control points comprises samples in a first reconstructed region adjacent to the current video block and samples in a second reconstructed region non-adjacent to the current video block.

Clause 11. The method of clause 5, wherein a first shape of a first template of a first control point in the plurality of control points is different from a second shape of a second template of a second control point in the plurality of control points.

Clause 12. The method of clause 11, wherein the first shape comprises an L-shape, and the first template comprises above and left neighboring samples of the current video block, and/or the second shape comprises an I-shape or a horizontal line shape, and the second template comprises one of: left neighboring samples of the current video block, or above neighboring samples of the current video block.

Clause 13. The method of clause 5, wherein a shape of a template in the plurality of templates is determined based on a position of a correspond control point.

Clause 14. The method of clause 13, wherein for a first control point at a top-left corner of the current video block, a shape of a corresponding template of the first control point is an L-shape, and the corresponding template comprises above and left neighboring samples of the current video block.

Clause 15. The method of clause 13, wherein for a second control point at a top-right corner of the current video block, a shape of a corresponding template of the second control point is a horizontal line shape, and the corresponding template comprises above neighboring samples of the current video block.

Clause 16. The method of clause 13, wherein for a first control point at a top-left corner of the current video block, a shape of a corresponding template of the first control point is an I-shape, and the corresponding template comprises left neighboring samples of the current video block.

Clause 17. The method of any of clauses 13-16, wherein for a control point of the current video block, a shape of a first template in a current picture is the same with a shape of a second template in a reference picture, the first template and the second template being associated with the control point.

Clause 18. The method of clause 17, wherein a template of the control point comprises neighboring samples in the first template and neighboring samples in the second template.

Clause 19. The method of clause 17 or clause 18, wherein the second template is located based on a motion vector of the current video block.

Clause 20. The method of any of clauses 5-19, wherein a first template of a first control point comprises a first number of samples, and a second template of a second control point comprises a second number of samples, the first number being different from the second number.

Clause 21. The method of clause 20, wherein a first line of samples in the first template is different from a second line of samples in the second template, a line of samples comprising a row of samples or a column of samples.

Clause 22. The method of any of clauses 5-19, wherein a first template of a first control point comprises a first number of samples, and a second template of a second control point comprises a second number of samples, the first number being the same with the second number.

Clause 23. The method of any of clauses 1-22, wherein performing the refinement process comprises: determining a unified template associated with the current video block; determining a template matching cost of the unified template; and performing the refinement process based on the template matching cost.

Clause 24. The method of clause 23, wherein a motion vector shift value is determined based on the template matching cost.

Clause 25. The method of clause 23, wherein a control point motion vector combination is determined based on the template matching cost.

Clause 26. The method of any of clauses 23-25, wherein the unified template comprises at least a partial of adjacent samples of the current video block.

Clause 27. The method of any of clauses 1-26, wherein a template of the current video block comprises samples of at least one of: a luma component, or a chroma component.

Clause 28. The method of any of clauses 1-27, wherein a template of the current video block comprises at least a partial of pixels in a region.

Clause 29. The method of any of clauses 1-28, wherein performing the refinement process comprises: performing a control point motion vector refinement process on at least one affine candidate of the current video block; and determining an affine candidate list of the current video block by adding the at least one refined affine candidate into the affine candidate list.

Clause 30. The method of any of clauses 1-28, further comprising: determining an affine candidate list of the current video block; and wherein performing the refinement process comprises: performing a control point motion vector refinement process on at least one affine candidate in the affine candidate list.

Clause 31. The method of clause 30, wherein the control point motion vector refinement process is performed on an affine candidate with an index.

Clause 32. The method of any of clauses 1-31, further comprising: determining a first affine candidate list of the current video block; and determining a second affine candidate list of the current video block.

Clause 33. The method of clause 32 or clause 33, wherein the first affine candidate list is determined without the refinement process.

Clause 34. The method of clause 32 or clause 33, wherein the second affine candidate list is determined based on the first affine candidate list.

Clause 35. The method of clause 34, wherein determining the second affine candidate list comprises: determining a candidate in the second affine candidate list by performing a control point motion vector refinement process on at least one control point motion vector in the first affine candidate list.

Clause 36. The method of clause 34, wherein the control point motion vector refinement process is based on template matching.

Clause 37. The method of any of clauses 32-36, wherein the first affine candidate list is determined based on a candidate reordering process.

Clause 38. The method of clause 37, wherein the candidate reordering process is based on template

Clause 39. The method of any of clauses 32-38, wherein the second affine candidate list is determined without a candidate reordering process.

Clause 40. The method of any of clauses 32-39, wherein the first affine candidate list is determined with a first pruning process, and the second affine candidate list is determined with a second pruning process, a first pruning rule of the first pruning process being different from a second pruning rule of the second pruning process.

Clause 41. The method of clause 49, wherein a first threshold for motion similarity check in the first pruning process is different from a second threshold for motion similarity check in the second pruning process.

Clause 42. The method of clause 41, wherein the second threshold is based on a block dimension of the current video block.

Clause 43. The method of clause 41, wherein the second threshold is a fixed value.

Clause 44. The method of any of clauses 1-43, wherein preforming the refinement process comprises: performing the refinement process on at least one control point motion vector of an affine candidate of the current video block based on template matching; and wherein performing the conversion comprises: determining, based on the at least one refined control point motion vector, affine motion information for at least one of the current video block or a subblock of the current video block.

Clause 45. The method of clause 44, wherein at least one of an integer precision or a fractional precision is used in the refinement process.

Clause 46. The method of clause 44, wherein an integer precision is used in the refinement process, and a fractional precision searching is skipped.

Clause 47. The method of clause 44, wherein performing of a fractional precision searching on the affine candidate is based on a result of an integer precision search.

Clause 48. The method of clause 44, wherein the factional precision is used in the refinement process, and an interpolation filter is used to determine at least one reference template for at least one motion vector pointing to at least one fractional position.

Clause 49. The method of clause 48, wherein the interpolation filter comprises a simplified interpolation filter.

Clause 50. The method of clause 48 or clause 49, wherein the interpolation filter comprises at least one of: a 2-tap bilinear filter, a 4-tap, 6-tap or 8-tap discrete cosine transform filter, a 4-tap, 6-tap or 8-tap discrete sine transform filter, or a 4-tap, 6-tap or 8-tap Lanczos filter.

Clause 51. The method of clause 48, wherein the interpolation filter comprises an interpolation filter with a filter taps longer than a threshold length.

Clause 52. The method of any of clauses 44-51, wherein whether to and/or how to use the method is determined based on the bitstream, or coding information of the current video block.

Clause 53. The method of clause 52, wherein whether to and/or how to use the method is included in at least one of: a sequence parameter set (SPS), a picture parameter set (PPS), a picture header, a slice header, a coding tree unit (CTU), or a coding unit (CU).

Clause 54. The method of clause 52, wherein the coding information comprises at least one of: a coding tool applied to the current video block, or a block dimension of the current video block.

Clause 55. The method of any of clauses 1-54, wherein preforming the refinement process comprises: performing the refinement process on motion information of a plurality of control points based on a target motion vector shift value, the target motion vector shift value being a difference between a control point motion vector and a corresponding refined control point motion vector.

Clause 56. The method of clause 55, further comprising: traversing a plurality of motion vector shift values in a motion vector shift set, the plurality of motion vector shift value being assigned to at least one control point motion vector of the current video block, wherein traversing a given motion vector shift value of the plurality of motion vector shift values comprises: determining a refined control point motion vector based on the given motion vector shift value and the at least one control point motion vector; determining motion information of at least one boundary subblock associated with the at least one refined control point motion vector; and determining a template matching cost corresponding to the given motion vector shift value based on the motion information; and determining the target motion vector shift value based on a plurality of template matching costs corresponding to the plurality of motion vector shift values.

Clause 57. The method of any of clauses 1-54, wherein a first motion vector shift value associated with a first control point of the current video block is different from a second motion vector shift value associated with a second control point of the current video block, a motion vector shift value being a difference between a control point motion vector and a corresponding refined control point motion vector.

Clause 58. The method of any of clauses 1-57, further comprising: determining a plurality of candidate control point motion vectors of a plurality of control points associated with the current video block; determining a plurality of refined control point motion vectors based on the plurality of candidate control point motion vectors; and determining a target control point motion vector combination at least based on the plurality of refined control point motion vectors, the target control point motion vector being used in the refinement process.

Clause 59. The method of clause 58, wherein the target control point motion vector combination comprises the plurality of refined control point motion vectors.

Clause 60. The method of clause 58, wherein determining the target control point motion vector combination comprises: determining a plurality of control point motion vector combination, each control point motion vector combination comprising respective control point motion vectors of the plurality of control points, a respective control point motion vector comprising a candidate control point motion vector or a refined control point motion vector; determining a plurality of template matching costs based on the plurality of control point motion vector combinations; and determining a target control point motion vector combination based on the plurality of template matching costs, the target control point motion vector being used in the refinement process.

Clause 61. The method of clause 60, wherein at least a partial of the plurality of control points is refined based on respective templates of the plurality of control points.

Clause 62. The method of clause 60 or clause 61, wherein determining the plurality of template matching costs comprises: for a control point motion vector combination in the plurality of control point motion vector combinations, determining subblock level motion information of at least one boundary subblock of the current video block; and determining a corresponding template matching cost based on the subblock level motion information.

Clause 63. The method of clause 62, wherein the at least one boundary subblock comprises a partial of boundary subblocks of the current video block.

Clause 64. The method of any of clauses 58-63, wherein the target control point motion vector combination is associated with a minimum template matching cost, and the target control point motion vector combination is determined as a refined affine candidate of the current video block.

Clause 65. The method of clause 64, wherein a second pass of control point refinement process is performed on the refined affine candidate to further refine each control point.

Clause 66. The method of clause 65, wherein each control point motion vector of the refined affine candidate is further iteratively refined to minimize a template matching cost of the current video block.

Clause 67. The method of clause 66, wherein in a given iteration, a control point motion vector is refined, and other control point motion vectors are fixed.

Clause 68. The method of any of clauses 1-67, wherein the refinement process is used with a regression based affine candidate derivation.

Clause 69. The method of clause 68, wherein performing the refinement process comprises: performing the refinement process on at least a partial of control point motion vectors of the current video block based on template matching to obtain a first refined affine candidate, and wherein the method further comprising: determining motion information of at least one boundary subblock associated with the first refined affine candidate; determining a second affine candidate based on the motion information and a regression model; and determining a target affine candidate by comparing a first template matching cost of at least one boundary subblock with the first refined affine candidate and a second template matching cost of at least one boundary subblock with the second affine candidate.

Clause 70. The method of clause 68, wherein performing the refinement process comprises: performing an integer precision refinement process on at least a partial of control point motion vectors of the current video block based on template matching to obtain a first refined affine candidate, and performing a fractional precision refinement process on the first refined affine candidate to obtain a second refined affine candidate; and wherein the method further comprising: determining motion information of the at least one boundary subblock associated with the first refined affine candidate; determining a third affine candidate based on the motion information and a regression model; and determining a target affine candidate by comparing a first template matching cost of the at least one boundary subblock with the second refined affine candidate and a second template matching cost of the at least one boundary subblock with the third affine candidate.

Clause 71. The method of clause 69 or clause 70, wherein the at least one subblock comprises a partial of boundary subblocks of the current video block.

Clause 72. The method of any of clauses 1-71, wherein the refinement process is based on template matching, and the refinement process is applied to at least one of: an affine merge candidate, or an affine advanced motion vector prediction (AMVP), or an affine inter prediction.

Clause 73. The method of clause 72, wherein a motion vector prediction (MVP) of the affine AMVP is refined based on at least one of template matching or decoder side motion vector refinement (DMVR).

Clause 74. The method of any of clauses 1-73, wherein the current video block is affine coded, and a template matching based refinement process is applied to the current video block together with a decoder side motion vector refinement (DMVR) based refinement process.

Clause 75. The method of clause 74, wherein the template matching based refinement process is applied before or after the DMVR based refinement process.

Clause 76. The method of any of clauses 1-73, wherein the current video block is affine coded without being applied a decoder side motion vector refinement (DMVR) based refinement process, and a template matching based refinement process is applied to the current video block.

Clause 77. The method of any of clauses 1-76, further comprising: determining a template matching cost of the current video block based on whether the current video block is bi-predicted or uni-predicted.

Clause 78. The method of clause 77, wherein the current video block is bi-predicted, and the template matching cost is determined based on a bi-prediction on template matching.

Clause 79. The method of clause 78, wherein the template matching cost is determined based on a weighted sum of a first reference template matching cost associated with a first reference list and a second reference template matching cost associated with a second reference list.

Clause 80. The method of clause 79, wherein a sum of a first weight of the first reference template matching cost and a second weight of the second reference template matching cost is one.

Clause 81. The method of clause 80, wherein the first weight is 0.5.

Clause 82. The method of clause 80, wherein the first weight is determined based on an index of a bi-prediction with coding unit level weight (BCW).

Clause 83. The method of any of clauses 79-83, wherein the first reference template matching cost is determined based on at least one control point motion vector in the first reference list, and the second reference template matching cost is determined based on at least one control point motion vector in the second reference list.

Clause 84. The method of clause 77, wherein the current video block is bi-predicted, and a first template matching cost is determined for a first reference list and a second template matching cost is determined for a second reference list.

Clause 85. The method of any of clauses 1-84, wherein the refinement process on at least one control point motion vector of the current video block is performed iteratively.

Clause 86. The method of clause 85, wherein in a step of the refinement process, a first control point motion vector is refined, and other control point motion vectors are fixed.

Clause 87. The method of clause 85, wherein a first refined control point motion vector is used in a subsequent refinement for a second control point motion vector.

Clause 88. The method of clause 85, wherein a first control point motion vector without refining is used in a subsequent refinement for a second control point motion vector.

Clause 89. The method of any of clauses 85-88, wherein the current video block is bi-predicted.

Clause 90. The method of clause 89, wherein a first control point motion vector associated with a first reference list is refined before refining a second control point motion vector associated with a second reference list.

Clause 91. The method of clause 90, wherein whether to and/or how to refine the second control point motion vector in the second reference list is determined based on the refined first control point motion vector.

Clause 92. The method of clause 89, wherein a first control point motion vector associated with a first reference list and a second control point motion vector associated with a second reference list are refined separately.

Clause 93. The method of clause 92, wherein during refining the first control point motion vector, for a searching step, a uni-directional reference template matching in the first reference list is determined based on the first control point motion vector, a template matching cost is determined based on the uni-directional reference template matching to obtain a motion vector shift value.

Clause 94. The method of clause 89, wherein a first control point motion vector associated with a first reference list and a second control point motion vector associated with a second reference list are jointly refined.

Clause 95. The method of clause 94, wherein during refining the first control point motion vector, for a searching step, a bi-directional reference template matching is determined based on the first control point motion vector and the second control point motion vector, a template matching cost is determined based on the bi-directional reference template matching to obtain a motion vector shift value.

Clause 96. The method of any of clauses 1-95, wherein performing the refinement process comprises: performing a plurality of rounds of the refinement process to a plurality of control point motion vectors of the current video block.

Clause 97. The method of clause 96, wherein at least a partial of the plurality of control point motion vectors is refined in a round of the plurality of rounds of the refinement process.

Clause 98. The method of clause 96, wherein at least a partial of the plurality of control point motion vectors is refined in a first round of the plurality of rounds of the refinement process, and a second round of the refinement process is further performed on the at least partial of the refined plurality of control point motion vectors.

Clause 99. The method of any of clauses 1-98, wherein whether to and/or how to refine at least one control point motion vector of the current video block based on template matching is determined based on a prediction direction of the current video block.

Clause 100. The method of clause 99, wherein the current video block is uni-predicted, and the at least one control point motion vector is to be refined based on template matching.

Clause 101. The method of clause 99, wherein the current video block is bi-predicted, and the at least one control point motion vector is to be refined based on template matching.

Clause 102. The method of clause 99, wherein the current video block is bi-predicted or uni-predicted, and the at least one control point motion vector is to be refined based on template matching.

Clause 103. The method of any of clauses 1-102, wherein an affine prediction is used as a hypothesis of the current video block coded with multiple hypothesis prediction (MHP).

Clause 104. The method of any of clauses 1-103, wherein whether to and/or how to apply the method is based on a syntax element in the bitstream.

Clause 105. The method of clause 104, wherein the syntax element is at at least one of: a sequence level, a group of pictures level, a picture level, a slice level, or a tile group level.

Clause 106. The method of clause 104 or clause 105, wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

Clause 107. The method of any of clauses 104-106, wherein the syntax element is indicated in a region containing more than one sample or pixel.

Clause 108. The method of clause 107, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

Clause 109. The method of any of clauses 1-103, wherein whether to and/or how to apply the method is determined based on coding information of the current video block.

Clause 110. The method of clause 109, wherein the coding information comprises at least one of: a block size of the current video block, a color format of the current video block, a single or dual tree partitioning of the current video block, a color component of the current video block, a slice type of the current video block, or a picture type of the current video block.

Clause 111. The method of any of clauses 1-110, wherein whether a first syntax element indicating if a template matching based refinement process is applied to a control point motion vector of the current video block is determined based on a second syntax element.

Clause 112. The method of any of clauses 1-111, wherein the conversion includes encoding the current video block into the bitstream.

Clause 113. The method of any of clauses 1-111, wherein the conversion includes decoding the current video block from the bitstream.

Clause 114. An apparatus for video processing comprising a processor and a non-transitory memory with instructions thereon, wherein the instructions upon execution by the processor, cause the processor to perform a method in accordance with any of clauses 1-113.

Clause 115. A non-transitory computer-readable storage medium storing instructions that cause a processor to perform a method in accordance with any of clauses 1-113.

Clause 116. A non-transitory computer-readable recording medium storing a bitstream of a video which is generated by a method performed by an apparatus for video processing, wherein the method comprises: determining affine motion compensation information of a current video block of the video; preforming a refinement process on the affine motion compensation information based on at least one sample previously coded to obtain refined affine motion compensation information; and generating the bitstream based on the refined affine motion compensation information.

Clause 117. A method for storing a bitstream of a video, comprising: determining affine motion compensation information of a current video block of the video; preforming a refinement process on the affine motion compensation information based on at least one sample previously coded to obtain refined affine motion compensation information; generating the bitstream based on the refined affine motion compensation information; and storing the bitstream in a non-transitory computer-readable recording medium.

### Example Device

FIG. 20 illustrates a block diagram of a computing device 2000 in which various embodiments of the present disclosure can be implemented. The computing device 2000 may be implemented as or included in the source device 110 (or the video encoder 114 or 200) or the destination device 120 (or the video decoder 124 or 300).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement video encoding/decoding in embodiments of the present disclosure. The memory 2020 may include one or more video coding modules 2025 having one or more program instructions. These modules are accessible and executable by the processing unit 2010 to perform the functionalities of the various embodiments described herein.

In the example embodiments of performing video encoding, the input device 2050 may receive video data as an input 2070 to be encoded. The video data may be processed, for example, by the video coding module 2025, to generate an encoded bitstream. The encoded bitstream may be provided via the output device 2060 as an output 2080.

In the example embodiments of performing video decoding, the input device 2050 may receive an encoded bitstream as the input 2070. The encoded bitstream may be processed, for example, by the video coding module 2025, to generate decoded video data. The decoded video data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
determining, for a conversion between a current video block of a video and a bitstream of the video, affine motion compensation information of the current video block;
preforming a refinement process on the affine motion compensation information based on at least one sample previously coded to obtain refined affine motion compensation information; and
performing the conversion based on the refined affine motion compensation information.

2. The method of claim 1, wherein the affine motion compensation information comprises at least one of: a control point motion vector of the current video block, a motion vector of a subblock of the current video block, or an affine parameter for an affine coding mode, and/or
wherein the at least one sample comprises at least one of: samples in a first template of the current video block, or samples in a second template of a reference block of the current video block, and/or
wherein at least one of the first template or the second template comprises a reconstructed region, and samples in the reconstructed region is used to refine a control point motion vector of the current video block.

3. The method of claim 1, wherein performing the refinement process comprises:
determining a unified template associated with the current video block;
determining a template matching cost of the unified template; and
performing the refinement process based on the template matching cost, wherein a motion vector shift value is determined based on the template matching cost.

4. The method of claim 1, wherein a template of the current video block comprises samples of at least one of: a luma component, or a chroma component, and/or
wherein a template of the current video block comprises at least a partial of pixels in a region.

5. The method of claim 1, wherein performing the refinement process comprises:
performing a control point motion vector refinement process on at least one affine candidate of the current video block; and
determining an affine candidate list of the current video block by adding the at least one refined affine candidate into the affine candidate list.

6. The method of claim 1, further comprising:
determining an affine candidate list of the current video block; and
wherein performing the refinement process comprises: performing a control point motion vector refinement process on at least one affine candidate in the affine candidate list,
wherein the control point motion vector refinement process is performed on an affine candidate with an index.

7. The method of claim 1, further comprising:
determining a first affine candidate list of the current video block; and
determining a second affine candidate list of the current video block,
wherein the first affine candidate list is determined without the refinement process, and/or
wherein the second affine candidate list is determined based on the first affine candidate list,
wherein determining the second affine candidate list comprises: determining a candidate in the second affine candidate list by performing a control point motion vector refinement process on at least one control point motion vector in the first affine candidate list, and/or
wherein the control point motion vector refinement process is based on template matching, and/or
wherein the first affine candidate list is determined based on a candidate reordering process, wherein the candidate reordering process is based on template matching, and/or
wherein the second affine candidate list is determined without a candidate reordering process.

8. The method of claim 7, wherein the first affine candidate list is determined with a first pruning process, and the second affine candidate list is determined with a second pruning process, a first pruning rule of the first pruning process being different from a second pruning rule of the second pruning process,
wherein a first threshold for motion similarity check in the first pruning process is different from a second threshold for motion similarity check in the second pruning process,
wherein the second threshold is based on a block dimension of the current video block, or wherein the second threshold is a fixed value.

9. The method of claim 1, wherein preforming the refinement process comprises:
performing the refinement process on at least one control point motion vector of an affine candidate of the current video block based on template matching, and
wherein performing the conversion comprises: determining, based on the at least one refined control point motion vector, affine motion information for at least one of the current video block or a subblock of the current video block,
wherein at least one of an integer precision or a fractional precision is used in the refinement process, or
wherein an integer precision is used in the refinement process, and a fractional precision searching is skipped, or
wherein performing a fractional precision searching on the affine candidate is based on a result of an integer precision search, or
wherein the factional precision is used in the refinement process, and an interpolation filter is used to determine at least one reference template for at least one motion vector pointing to at least one fractional position, wherein the interpolation filter comprises a simplified interpolation filter, and/or wherein the interpolation filter comprises at least one of: a 2-tap bilinear filter, a 4-tap, 6-tap or 8-tap discrete cosine transform filter, a 4-tap, 6-tap or 8-tap discrete sine transform filter, or a 4-tap, 6-tap or 8-tap Lanczos filter,
wherein whether to and/or how to use the method is determined based on the bitstream, or coding information of the current video block,
wherein whether to and/or how to use the method is included in at least one of: a sequence parameter set (SPS), a picture parameter set (PPS), a picture header, a slice header, a coding tree unit (CTU), or a coding unit (CU),
wherein the coding information comprises at least one of: a coding tool applied to the current video block, or a block dimension of the current video block.

10. The method of claim 1, wherein preforming the refinement process comprises:
performing the refinement process on motion information of a plurality of control points based on a target motion vector shift value, the target motion vector shift value being a difference between a control point motion vector and a corresponding refined control point motion vector,
wherein the method further comprises: traversing a plurality of motion vector shift values in a motion vector shift set, the plurality of motion vector shift value being assigned to at least one control point motion vector of the current video block,
wherein traversing a given motion vector shift value of the plurality of motion vector shift values comprises:
determining a refined control point motion vector based on the given motion vector shift value and the at least one control point motion vector;
determining motion information of at least one boundary subblock associated with the at least one refined control point motion vector; and
determining a template matching cost corresponding to the given motion vector shift value based on the motion information; and
determining the target motion vector shift value based on a plurality of template matching costs corresponding to the plurality of motion vector shift values.

11. The method of claim 10, wherein the refinement process is used with a regression based affine candidate derivation,
wherein performing the refinement process comprises: performing the refinement process on at least a partial of control point motion vectors of the current video block based on template matching to obtain a first refined affine candidate, and wherein the method further comprising:
determining motion information of at least one boundary subblock associated with the first refined affine candidate;
determining a second affine candidate based on the motion information and a regression model; and
determining a target affine candidate by comparing a first template matching cost of at least one boundary subblock with the first refined affine candidate and a second template matching cost of at least one boundary subblock with the second affine candidate, or
wherein performing the refinement process comprises: performing an integer precision refinement process on at least a partial of control point motion vectors of the current video block based on template matching to obtain a first refined affine candidate, and performing a fractional precision refinement process on the first refined affine candidate to obtain a second refined affine candidate; and wherein the method further comprising:
determining motion information of the at least one boundary subblock associated with the first refined affine candidate;
determining a third affine candidate based on the motion information and a regression model; and
determining a target affine candidate by comparing a first template matching cost of the at least one boundary subblock with the second refined affine candidate and a second template matching cost of the at least one boundary subblock with the third affine candidate,
wherein the at least one subblock comprises a partial of boundary subblocks of the current video block.

12. The method of claim 1, wherein the refinement process is based on template matching, and the refinement process is applied to at least one of: an affine merge candidate, or an affine advanced motion vector prediction (AMVP), or an affine inter prediction, wherein a motion vector prediction (MVP) of the affine AMVP is refined based on at least one of template matching or decoder side motion vector refinement (DMVR), and/or
wherein the current video block is affine coded, and a template matching based refinement process is applied to the current video block together with a decoder side motion vector refinement (DMVR) based refinement process, wherein the template matching based refinement process is applied before or after the DMVR based refinement process, and/or
wherein the current video block is affine coded without being applied a decoder side motion vector refinement (DMVR) based refinement process, and a template matching based refinement process is applied to the current video block.

13. The method of claim 1, further comprising: determining a template matching cost of the current video block based on whether the current video block is bi-predicted or uni-predicted,
wherein the current video block is bi-predicted, and the template matching cost is determined based on a bi-prediction on template matching,
wherein the template matching cost is determined based on a weighted sum of a first reference template matching cost associated with a first reference list and a second reference template matching cost associated with a second reference list,
wherein a sum of a first weight of the first reference template matching cost and a second weight of the second reference template matching cost is one, wherein the first weight is 0.5, or wherein the first weight is determined based on an index of a bi-prediction with coding unit level weight (BCW), and/or
wherein the first reference template matching cost is determined based on at least one control point motion vector in the first reference list, and the second reference template matching cost is determined based on at least one control point motion vector in the second reference list.

14. The method of claim 1, wherein the refinement process on at least one control point motion vector of the current video block is performed iteratively, wherein the current video block is bi-predicted, and wherein a first control point motion vector associated with a first reference list and a second control point motion vector associated with a second reference list are jointly refined, and/or
wherein during refining the first control point motion vector, for a searching step, a bi-directional reference template matching is determined based on the first control point motion vector and the second control point motion vector, a template matching cost is determined based on the bi-directional reference template matching to obtain a motion vector shift value.

15. The method of claim 1, wherein performing the refinement process comprises:
performing a plurality of rounds of the refinement process to a plurality of control point motion vectors of the current video block,
wherein at least a partial of the plurality of control point motion vectors is refined in a round of the plurality of rounds of the refinement process,
wherein at least a partial of the plurality of control point motion vectors is refined in a first round of the plurality of rounds of the refinement process, and a second round of the refinement process is further performed on the at least partial of the refined plurality of control point motion vectors.

16. The method of claim 1, wherein whether to and/or how to refine at least one control point motion vector of the current video block based on template matching is determined based on a prediction direction of the current video block,
wherein the current video block is uni-predicted, and the at least one control point motion vector is to be refined based on template matching, or
wherein the current video block is bi-predicted, and the at least one control point motion vector is to be refined based on template matching, or
wherein the current video block is bi-predicted or uni-predicted, and the at least one control point motion vector is to be refined based on template matching, and/or
wherein an affine prediction is used as a hypothesis of the current video block coded with multiple hypothesis prediction (MHP).

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, affine motion compensation information of the current video block;
preform a refinement process on the affine motion compensation information based on at least one sample previously coded to obtain refined affine motion compensation information; and
perform the conversion based on the refined affine motion compensation information.

19. A non-transitory computer-readable storage medium storing instructions that cause a processor to perform a method comprising:
determining, for a conversion between a current video block of a video and a bitstream of the video, affine motion compensation information of the current video block;
preforming a refinement process on the affine motion compensation information based on at least one sample previously coded to obtain refined affine motion compensation information; and
performing the conversion based on the refined affine motion compensation information.

20. A non-transitory computer-readable recording medium storing a bitstream of a video which is generated by a method performed by an apparatus for video processing, wherein the method comprises:
determining affine motion compensation information of a current video block of the video;
preforming a refinement process on the affine motion compensation information based on at least one sample previously coded to obtain refined affine motion compensation information; and
generating the bitstream based on the refined affine motion compensation information.
